(19) United States
(12) Patent Application Publication
(10) Pub. No.: US 2025/0106885 A1
(43) Pub. Date: Mar. 27, 2025

(54) TECHNIQUES FOR ADJUSTING A RESOURCE PRIORITY ASSOCIATED WITH A DUAL-SUBSCRIBER IDENTIFICATION MODULE DUAL-STANDBY USER EQUIPMENT

(71) Applicant: QUALCOMM Incorporated, San Diego, CA (US)

(72) Inventors: Rishav REJ, San Diego, CA (US); Uttam VYAS, Hyderabad (IN); Qingxin CHEN, San Diego, CA (US); Uttam PATTANAYAK, San Diego, CA (US); Touseef KHAN, San Diego, CA (US); Ling XIE, Beijing (CN); Bhupesh Manoharlal UMATT, Poway, CA (US); Manisha PRIYADARSHINI, San Diego, CA (US); Mutaz Zuhier Afif SHUKAIR, San Diego, CA (US)

(21) Appl. No.: 18/728,275

(22) PCT Filed: Mar. 23, 2022
(86) PCT No.: PCT/CN2022/082400

§ 371 Date: Jul. 11, 2024

(51) Int. Cl. H04W 72/563; H04W 72/0446; H04W 88/06

(52) U.S. Cl. CPC H04W 72/563; H04W 72/0446; H04W 88/06

(57) ABSTRACT

Various aspects of the present disclosure generally relate to wireless communication. In some aspects, a user equipment (UE) may identify a first service associated with a first subscriber identification module (SIM), the first service having a first priority. The UE may identify at least one re-prioritization condition that is satisfied, wherein the at least one re-prioritization condition is associated with at least one of the first service or a second service associated with a second SIM, the second service having a second priority that is lower than the first priority. The UE may adjust, based at least in part on the at least one re-prioritization condition being satisfied, the second priority, wherein the adjusted second priority is higher than the first priority. The UE may perform a communication corresponding to the second service based at least in part on the adjusted second priority. Numerous other aspects are described.

### FIELD OF THE DISCLOSURE

Aspects of the present disclosure generally relate to wireless communication and to techniques and apparatuses for adjusting a resource priority associated with a dual-subscriber identification module dual-standby user equipment.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include identifying a first service associated with a first subscriber identification module (SIM) of the UE, the first service having a first priority. The method may include identifying at least one re-prioritization condition that is satisfied, wherein the at least one re-prioritization condition is associated with at least one of the first service or a second service associated with a second SIM of the UE, the second service having a second priority and the second priority is lower than the first priority. The method may include adjusting, based at least in part on the at least one re-prioritization condition being satisfied, the second priority, wherein the adjusted second priority is higher than the first priority. The method may include performing, during a time interval, a communication corresponding to the second service based at least in part on the adjusted second priority.

Some aspects described herein relate to a UE for wireless communication. The user equipment may include a memory and one or more processors coupled to the memory. The one or more processors may be configured to identify a first service associated with a first SIM of the UE, the first service having a first priority. The one or more processors may be configured to identify at least one re-prioritization condition that is satisfied, wherein the at least one re-prioritization condition is associated with at least one of the first service or a second service associated with a second SIM of the UE, the second service having a second priority and the second priority is lower than the first priority. The one or more processors may be configured to adjust, based at least in part on the at least one re-prioritization condition being satisfied, the second priority, wherein the adjusted second priority is higher than the first priority. The one or more processors may be configured to perform, during a time interval, a communication corresponding to the second service based at least in part on the adjusted second priority.

Some aspects described herein relate to a non-transitory computer-readable medium that stores a set of instructions for wireless communication by a UE. The set of instructions, when executed by one or more processors of the UE, may cause the UE to identify a first service associated with a first SIM of the UE, the first service having a first priority. The set of instructions, when executed by one or more processors of the UE, may cause the UE to identify at least one re-prioritization condition that is satisfied, wherein the at least one re-prioritization condition is associated with at least one of the first service or a second service associated with a second SIM of the UE, the second service having a second priority and the second priority is lower than the first priority. The set of instructions, when executed by one or more processors of the UE, may cause the UE to adjust, based at least in part on the at least one re-prioritization condition being satisfied, the second priority, wherein the adjusted second priority is higher than the first priority. The set of instructions, when executed by one or more processors of the UE, may cause the UE to perform, during a time interval, a communication corresponding to the second service based at least in part on the adjusted second priority.

Some aspects described herein relate to an apparatus for wireless communication. The apparatus may include means for identifying a first service associated with a first SIM of the apparatus, the first service having a first priority. The apparatus may include means for identifying at least one re-prioritization condition that is satisfied, wherein the at least one re-prioritization condition is associated with at least one of the first service or a second service associated with a second SIM of the apparatus, the second service having a second priority and the second priority is lower than the first priority. The apparatus may include means for adjusting, based at least in part on the at least one re-prioritization condition being satisfied, the second priority, wherein the adjusted second priority is higher than the first priority. The apparatus may include means for performing, during a time interval, a communication corresponding to the second service based at least in part on the adjusted second priority.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a multiple subscriber identity module (multi-SIM) UE, in accordance with the present disclosure.

FIG. 4 is a diagram illustrating an example associated with adjusting a resource priority associated with a dual-subscriber identification module dual-standby (DSDS) UE, in accordance with the present disclosure.

FIG. 5 is a diagram illustrating an example process associated with adjusting a resource priority associated with a DSDS UE, in accordance with the present disclosure.

FIG. 6 is a diagram illustrating an example process associated with performing a local connection release associated with a DSDS UE, in accordance with the present disclosure.

FIG. 7 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

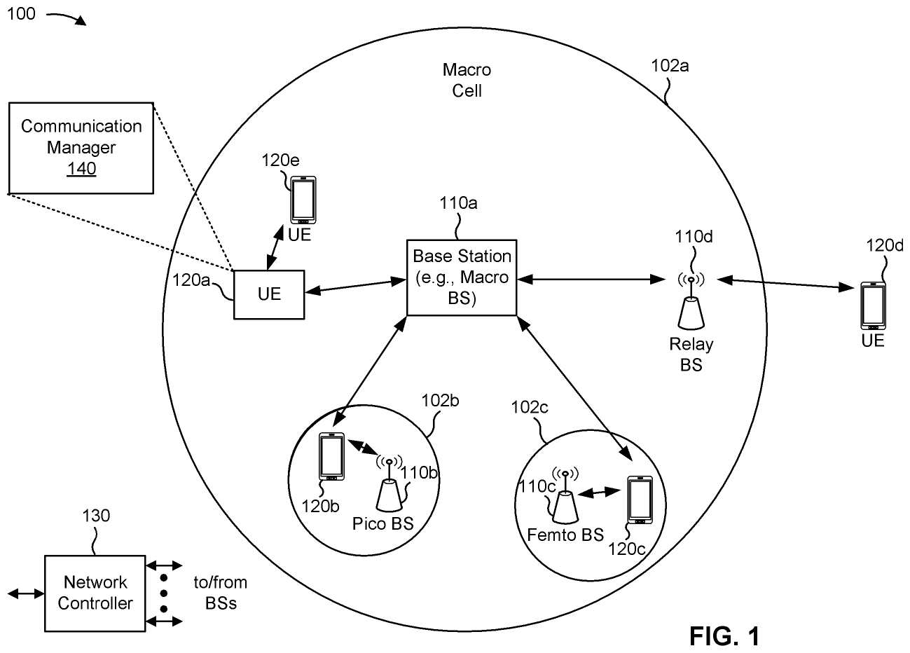

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

As described herein, a network node, which may be referred to as a “node,” a “network node,” or a “wireless node,” may be a base station (e.g., base station 110), a UE (e.g., UE 120), a relay device, a network controller, an apparatus, a device, a computing system, one or more components of any of these, and/or another processing entity configured to perform one or more aspects of the techniques described herein. For example, a network node may be a UE. As another example, a network node may be a base station. A network node may be an aggregated base station and/or one or more components of a disaggregated base station. As an example, a first network node may be configured to communicate with a second network node or a third network node. The adjectives “first,” “second,” “third,” and so on are used for contextual distinction between two or more of the modified noun in connection with a discussion and are not meant to be absolute modifiers that apply only to a certain respective node throughout the entire document. For example, a network node may be referred to as a “first network node” in connection with one discussion and may be referred to as a “second network node” in connection with another discussion, or vice versa. Reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses a first network node being configured to receive information from a second network node, “first network node” may refer to a first UE, a first base station, a first apparatus, a first device, a first computing system, a first one or more components, a first processing entity, or the like configured to receive the information from the second network; and “second network node” may refer to a second UE, a second base station, a second apparatus, a second device, a second computing system, a second one or more components, a second processing entity, or the like.

In some aspects, a UE (e.g., the UE 120) may include a communication manager 140. As described in more detail elsewhere herein, the communication manager 140 may identify a first service associated with a first subscriber identification module (SIM) of the UE, the first service having a first priority; identify at least one re-prioritization condition that is satisfied, wherein the at least one re-prioritization condition is associated with at least one of the first service or a second service associated with a second SIM of the UE, the second service having a second priority and the second priority is lower than the first priority; adjust, based at least in part on the at least one re-prioritization condition being satisfied, the second priority, wherein the adjusted second priority is higher than the first priority; and perform, during a time interval, a communication corresponding to the second service based at least in part on the adjusted second priority. Additionally, or alternatively, the communication manager 140 may perform one or more other operations described herein.

As indicated above, FIG. 1 is provided as an example. Other examples may differ from what is described with regard to FIG. 1.

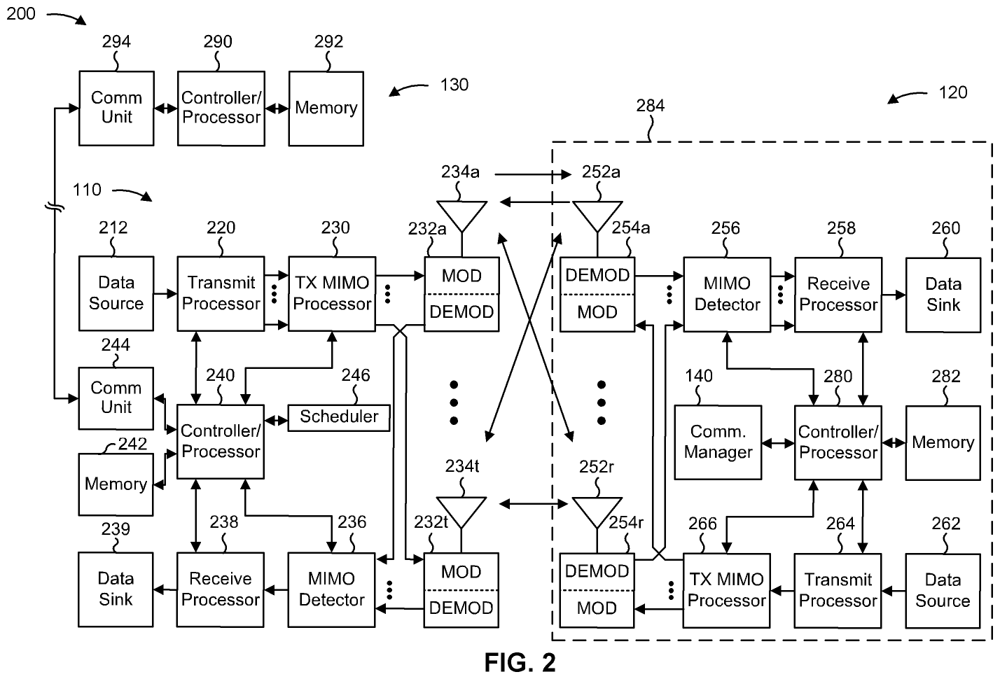

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

In some aspects, the term “base station” (e.g., the base station 110), “network node,” or “network entity” may refer to an aggregated base station, a disaggregated base station, an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

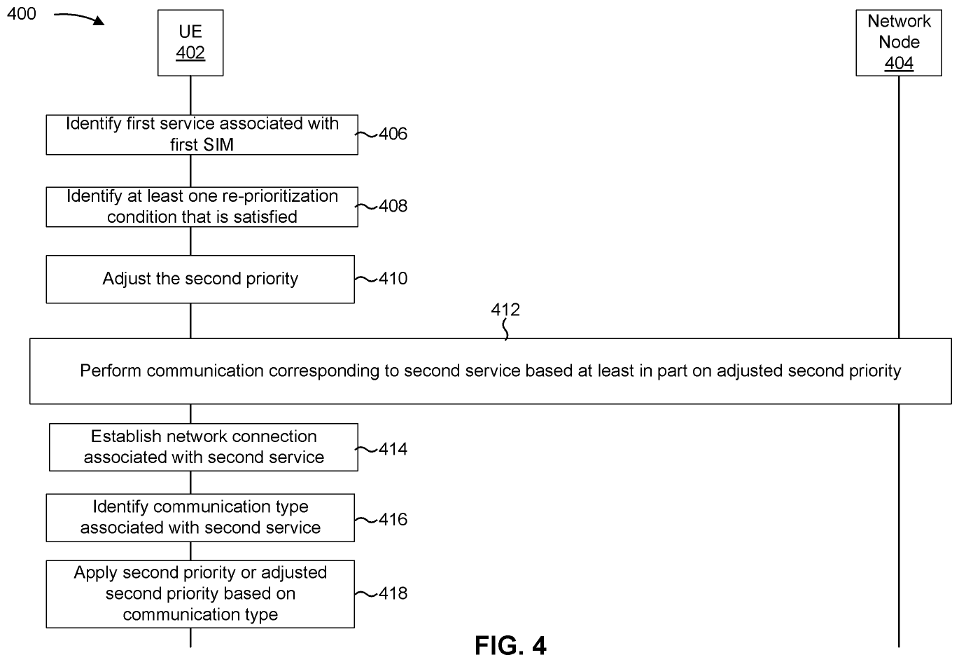

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-7).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-7).

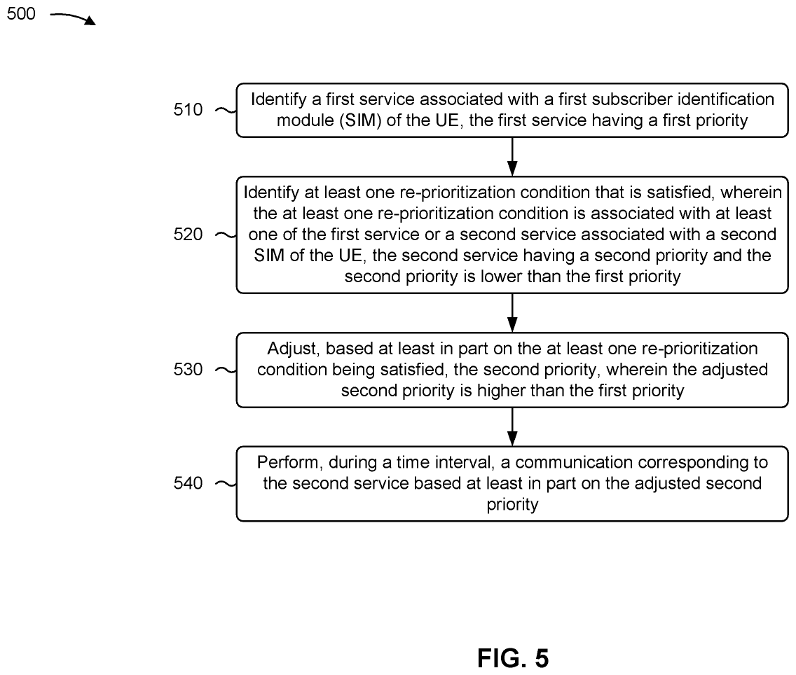

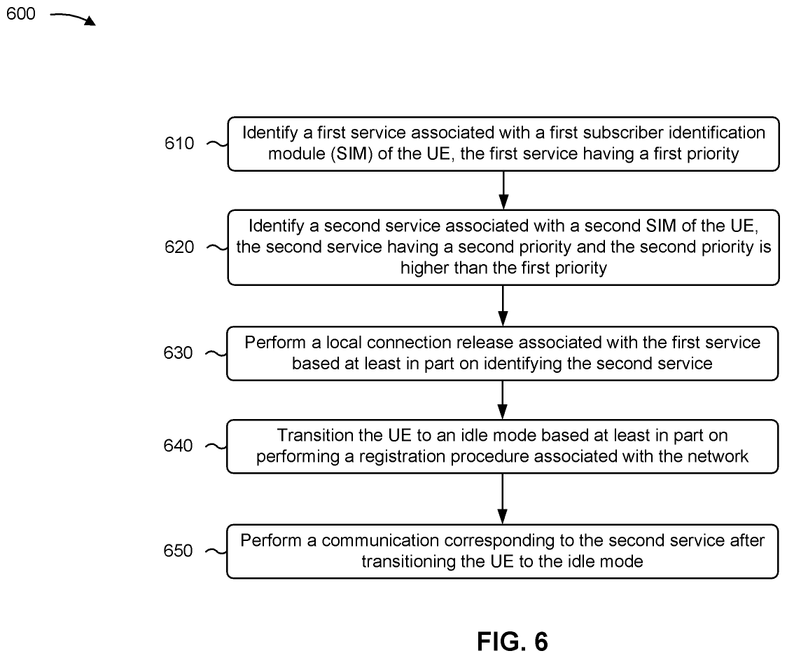

The controller/processor 240 of the base station 110, the controller/processor 280 of the UE 120, and/or any other component(s) of FIG. 2 may perform one or more techniques associated with adjusting a resource priority associated with a dual-subscriber identification module dual-standby (DSDS) UE, as described in more detail elsewhere herein. For example, the controller/processor 240 of the base station 110, the controller/processor 280 of the UE 120, and/or any other component(s) of FIG. 2 may perform or direct operations of, for example, process 500 of FIG. 5, process 600 of FIG. 6, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, process 600 of FIG. 6, and/or other processes as described herein. In some examples, executing instructions may include running the instructions, converting the instructions, compiling the instructions, and/or interpreting the instructions, among other examples.

In some aspects, a UE (e.g., the UE 120) includes means for identifying a first service associated with a first SIM of the UE, the first service having a first priority; means for identifying at least one re-prioritization condition that is satisfied, wherein the at least one re-prioritization condition is associated with at least one of the first service or a second service associated with a second SIM of the UE, the second service having a second priority and the second priority is lower than the first priority; means for adjusting, based at least in part on the at least one re-prioritization condition being satisfied, the second priority, wherein the adjusted second priority is higher than the first priority; and/or means for performing, during a time interval, a communication corresponding to the second service based at least in part on the adjusted second priority. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

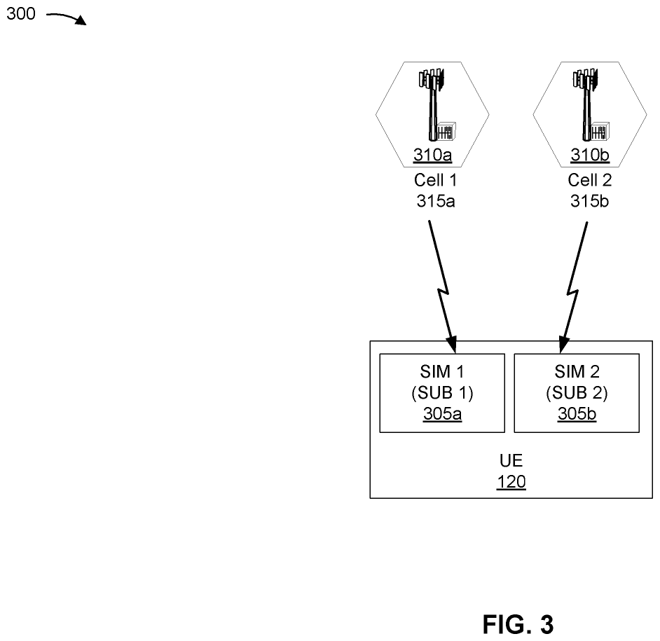

FIG. 3 is a diagram illustrating an example 300 of a multi-subscriber identity module (SIM) UE, in accordance with the present disclosure. As shown in FIG. 3, a UE 120 may be a multiple SIM (multi-SIM) UE that includes multiple SIMs (two or more SIMs), shown as a first SIM 305a and a second SIM 305b. The first SIM 305a may be associated with a first subscription (shown as SUB 1), and the second SIM 305b may be associated with a second subscription (shown as SUB 2). A subscription may be a subscription with a network operator (for example, a mobile network operator (MNO)) that enables the UE 120 to access a wireless network (for example, a radio access network (RAN)) associated with the network operator.

A SIM 305a and/or 305b may be a removable SIM (for example, a SIM card) or an embedded SIM. A SIM 305a and/or 305b may include an integrated circuit that securely stores an international mobile subscriber identity (IMSI) and a security key, which are used to identify and authenticate a corresponding subscription associated with the SIM 305a and/or 305b. In some cases, a SIM 305a and/or 305b may store a list of services that the UE 120 has permission to access using a subscription associated with the SIM 305a and/or 305b, such as a data service or a voice service, among other examples.

As further shown in FIG. 3, the UE 120 may communicate (for example, in a connected mode, an idle mode, or an inactive mode) with a first network node 310a via a first cell 315a (shown as Cell 1) using the first SIM 305a. In this case, a first subscription (SUB 1) of the UE 120 may be used to access the first cell 315a (for example, using a first IMSI for UE identification, using a first security key for UE authentication, using a first list of services that the UE 120 is permitted to access using the first subscription, or by counting data or voice usage on the first cell against the first subscription, among other examples). Similarly, the UE 120 may communicate (for example, in a connected mode, an idle mode, or an inactive mode) with a second network node 310b via a second cell 315b (shown as Cell 2) using the second SIM 305b. In this case, a second subscription (SUB 2) of the UE 120 may be used to access the second cell 315b (for example, using a second IMSI for UE identification, using a second security key for UE authentication, using a second list of services that the UE 120 is permitted to access using the second subscription, or by counting data or voice usage on the second cell against the second subscription, among other examples).

The first network node 310a and/or the second network node 310b may include one or more of the base stations 110 described above in connection with FIG. 1. Although the first cell 315a and the second cell 315b are shown as being provided by different network nodes, in some aspects, the first cell 315a and the second cell 315b may be provided by the same network node. Thus, in some aspects, the first network node 310a and the second network node 310b may be integrated into a single network node.

In some cases, the UE 120 may be capable of operating in a multi-SIM multiple standby (MSMS) mode, such as a dual SIM dual standby (DSDS) mode (e.g., when the UE 120 is associated with two subscriptions). Additionally, or alternatively, the UE 120 may be capable of operating in a multi-SIM multiple active (SR-MSMA) mode, such as a dual SIM dual active (DSDA) mode (e.g., when the UE 120 is associated with two subscriptions).

In a DSDA mode, the UE 120 is capable of concurrent active communication using both SIMs of the UE 120. Thus, a UE 120 in the DSDA mode is capable of communicating using the first SIM 305a (and the first subscription) at the same time as communicating using the second SIM 305b (and the second subscription). For example, when the UE 120 is in an active session (e.g., a voice call or another latency sensitive service, such as online gaming, stock trading, or an over-the-top (OTT) service) using the first SIM 305a, the UE 120 is capable of receiving a notification of a voice call using the second SIM 305b without interrupting communications that use the first SIM 305a, and without tuning or switching away from the first cell 315a to tune to the second cell 315b.

In a DSDS mode, the UE 120 is not capable of concurrent active communication using both SIMs of the UE 120. Thus, a UE 120 in the DSDS mode is not capable of communicating using the first SIM 305a (and the first subscription) at the same time as communicating using the second SIM 305b (and the second subscription). However, a UE 120 in the DSDS mode may be capable of switching between two separate mobile network services, may include hardware for maintaining multiple connections (for example, one connection per SIM) in a standby state, or may include hardware (for example, multiple transceivers) for maintaining multiple network connections at the same time, among other examples. However, a UE 120 in the DSDS mode may be capable of receiving data on only one connection at a time because radio frequency resources are shared between the multiple subscriptions. For example, a UE 120 in the DSDS mode may be associated with multiple subscriptions but may include only a single transceiver shared by the multiple subscriptions, a single transmit chain shared by the multiple subscriptions, or a single receive chain shared by the multiple subscriptions, among other examples.

In some examples, a UE 120 may be capable of operating in a DSDA mode for a first combination of RATs, and may not be capable of operating in a DSDA mode for a second combination of RATs. For example, the UE 120 may be capable of operating in a DSDA mode for NR+NR, where the first cell 315a (as well as the first SIM 305a and the first subscription) uses an NR RAT and the second cell 315b (as well as the second SIM 305b and the second subscription) also uses the NR RAT. However, the UE 120 may not be capable of operating in a DSDA mode for NR+LTE, where one of the first cell 315a (as well as the first SIM 305a and the first subscription) uses an NR RAT and the second cell 315b (as well as the second SIM 305b and the second subscription) uses an LTE RAT (or vice versa). In some aspects, the UE 120 may not be capable of operating in the DSDA mode for the second combination of RATs (e.g., NR+LTE), but be capable of operating in a DSDS mode for the second combination of RATs. This UE design reduces design costs as compared to enabling the UE 120 to operate using the DSDA mode for the second combination of RATs.

In some cases, the first SIM 305a can perform communication tasks associated with a long term data service (e.g., a packet-switched (PS) data service, a circuit-switched (CS) data service, and/or a multimedia messaging service (MMS), among other examples) and the second SIM 305b can perform communication tasks associated with internet data and/or voice calls. In some cases, the first SIM 305a and the second SIM 305b can both be configured to perform communication tasks associated with internet traffic. In a DSDS mode, radio frequency resources can be allocated to the first SIM 305a or the second SIM 305b for transmissions with respect to the respective services. Because, in a DSDS mode, the first SIM 305a and the second SIM 305b cannot transmit simultaneously, radio frequency resources may be allocated to only one SIM at a time.

A resource priority configuration may be used to allocate the limited transmit resources of the UE 120 for transmissions associated with the first service or transmission associated with the second service. Typically, a resource priority configuration is a subscription service priority scheme, in which priority is allocated to one service or the other service based at least in part on a priority (e.g., a priority level) associated with the service. In other words, in a subscription service priority scheme, priority may be allocated to a higher-priority service any time there is a conflict between a transmission of the higher-priority service and a transmission of a lower-priority service.

In multi-SIM designs, a dedicated data SIM (DDS) SUB can perform data communication along with call communications and, in some cases, is the dedicated preferred SUB for data communications. The nDDS SUB can primarily perform call related activity and other short term data activity such as short message service (SMS) communications and/or MMS communications. Since an nDDS is typically designed for short term data activity, the nDDS can have a higher priority in a resource priority configuration, so that the nDDS can finish its activity quickly and allow the DDS to continue with connection setup and/or data activity. However, as use cases evolve, nDDS is being used more often for long term data activity (e.g., data communications that occur over a longer time period than some other types of communications). Since the nDDS performs data activity using a higher priority, the DDS can be starved of radio frequency resources, which can lead to performance issues associated with the DDS such as, for example, mobile-terminated call failure, registration delay, and/or registration failure, among other examples.

For example, in some cases, an nDDS can be performing long term PS data traffic communications (e.g., in a temporary data switch case) and holding the radio frequency resources with a higher priority than a DDS. The DDS can receive a mobile-terminated call page (e.g., for a voice call). However, the DDS might not be able to get an allocation of radio frequency resources to use to establish a mobile-terminated call connection since the radio frequency resources are already allocated to the nDDS based on a higher priority. In this case, the DDS needs to wait for the nDDS PS data traffic activity to complete before the DDS can transmit a mobile-terminated call page response, which can lead to mobile-terminated call failure on the DDS.

In another example, the DDS SUB can move out of a service area, in which case, the nDDS can start performing long term PS data traffic and holding the radio frequency resources with higher priority. The DDS SUB can move back into a service area and camp on the network. However, the DDS cannot get an allocation of radio frequency resources to use to perform registration since the radio frequency resources are already allocated to the nDDS based on a higher priority. In this case, the DDS needs to wait for the nDDS PS data traffic activity to complete before the DDS can perform a registration procedure, which can lead to registration delay on the DDS. In some cases, the challenges discussed above can apply, equally, to a first SIM and a second SIM that perform one of more of the tasks described above with respect to an nDDS and a DDS, respectively.

Some aspects of the techniques and apparatuses described herein may facilitate adjusting radio frequency resource priorities to enhance performance of a UE operating in DSDS mode when a first SIM is performing long term data communications. In some aspects, for example, the UE may identify a first service associated with the first SIM. The first service may have a first priority, and a second service, associated with a second SIM, may have a second priority that is lower than the first priority. The UE may identify at least one re-prioritization condition that is satisfied and may, based at least in part on identifying the satisfied re-prioritization condition, adjust the second priority so that the adjusted second priority is higher than the first priority.

In this way, some aspects may facilitate giving resource priority to services associated with a SIM (e.g., mobile-terminated call services and/or registration services, among other examples) when another SIM, with higher priority, is holding the resources for long-term communications. For example, some aspects of the techniques described herein may facilitate mitigation of mobile-terminated call failure on a DDS and/or registration failure on a DDS due to long-term data communications on an nDDS. Some aspects may facilitate enhanced prioritization to support data services on both SIMS. Accordingly, some aspects may facilitate enhancing the performance of the otherwise lower priority SIM, thereby positively impacting device performance.

As indicated above, FIG. 3 is provided as an example. Other examples may differ from what is described with regard to FIG. 3.

FIG. 4 is a diagram illustrating an example 400 associated with adjusting a resource priority associated with a DSDS UE, in accordance with the present disclosure. As shown, example 400 includes a UE 402 and a network node 404. The UE 402 may be, be similar to, include, or be included in, the UE 120 depicted in FIGS. 1-3. In some aspects, the network node 404 may be, be similar to, include, or be included in, the network node 310a and/or 310b depicted in FIG. 3, and/or the base station 110 depicted in FIGS. 1 and 2.

As shown by reference number 406, the UE 402 may identify a first service associated with a first SIM of the UE. The first service may have a first priority, and a second service, associated with a second SIM of the UE, may have a second priority. The second priority may be lower than the first priority. In some aspects, the second SIM may include a DDS and the first SIM may include an nDDS. In some aspects, the first service may include a PS data traffic service, a CS data traffic service, and/or an MMS, among other examples.

As shown by reference number 408, the UE 402 may identify at least one re-prioritization condition that is satisfied. The at least one re-prioritization condition may be associated with at least one of the first service or the second service. In some aspects, for example, identifying the at least one re-prioritization condition that is satisfied may include determining that an inactive period corresponding to a periodic scheduling scheme associated with the first service satisfies a threshold. The periodic scheduling scheme may include a semi-persistent scheduling (SPS) configuration, a configured grant, or a discontinuous reception configuration. In some aspects, for example, the UE 402 may determine that the inactive period has a length that satisfies a length threshold. For example, the length threshold may correspond to a minimum length of an inactive period that will allow for communication corresponding to the second service during the inactive period. In this way, if the length of the inactive period is less than the minimum length, the length of the inactive period may satisfy the threshold, triggering the re-prioritization of the services. In some aspects, a scheduling pattern associated with the periodic scheduling scheme may be configured such that, even if an inactive period is long enough to accommodate the second service communications, it does not fall at a time that corresponds to a time at which the second service communication is to be transmitted. In this case, the UE 402 may determine that a re-prioritization condition is satisfied.

In some aspects, the UE 402 may identify the at least one re-prioritization condition that is satisfied based at least in part on determining that a timer associated with a re-prioritization delay period has expired before a completion of a communication associated with the first service. That is, for example, the UE 402 may start a timer associated with the re-prioritization delay period when the first service communication begins or based at least in part on occurrence of a trigger event associated with the second service. For example, the UE 402 may start the timer based at least in part on receiving a mobile-terminated call page. The timer re-prioritization delay period may be configured so that, if the first service is completed before expiration of the timer, the UE 402 may allocate radio frequency resources to the second SIM without adjusting priorities. In this way, some aspects may allow the first service to continue so long as the length of time associated with the communication is short enough to accommodate successful performance of communications associated with the second service.

In some aspects, the UE 402 may identify the at least one re-prioritization condition that is satisfied based at least in part on determining that the first service is associated with PS data traffic and/or CS data traffic. In this case, for example, the UE 402 may re-prioritize resource allocation to the second SIM so that the second SIM may perform a subscription connection setup procedure associated with the second service. If the UE 402, on the other hand, determines that the first service is associated with short-term traffic, the UE 402 may wait for the first service to complete before allocating the resources to the second SIM. In some aspects, the UE 402 may determine the type of data service using an application programming interface (API) associated with the first SIM.

In some aspects, the UE 402 may identify the re-prioritization condition that is satisfied based at least in part on any number of different performance metrics. For example, the UE 402 may evaluate a radio frequency condition associated with the first service, since poor radio frequency conditions may lead to long data services on the first SIM. In some aspects, the UE may determine that a radio frequency grant to the first SIM may starve the second SIM from getting radio frequency resources. In some aspects, the UE may determine that a BLER associated with the first service satisfies a BLER threshold and, thus, may lead to poor performance by the first SIM, which may lengthen the time occupied by the first service. In some aspects, the UE 402 may determine that a thermal control or a central processing unit (CPU) flow control associated with the first SIM has been activated, which may reduce carrier aggregation and/or MIMO capability, thereby elongating the first service. In some aspects, the UE 402 may determine that a power headroom associated with the first SIM and/or the second SIM satisfies a power headroom threshold. In some aspects, the UE 402 may determine that an SPS configuration and/or a configured grant is available for use by the second service, in which case, re-prioritization may not be desirable.

As shown by reference number 410, the UE 402 may adjust, based at least in part on the at least one re-prioritization condition being satisfied, the second priority, wherein the adjusted second priority is higher than the first priority. In some aspects, adjusting the second priority may refer to changing a priority level corresponding to the second priority. In some other aspects, adjusting the second priority may refer to changing a relationship between the first priority and the second priority. For example, in some aspects, adjusting the second priority may refer to changing a priority level of the first priority so that the second priority level is higher than the first priority level. In some aspects, adjusting the second priority may refer to changing a priority level of both the first priority and the second priority so that the adjusted second priority is higher than the adjusted first priority. In some aspects, adjusting the second priority may refer to changing a time interval corresponding to the first priority and/or the second priority so that the second priority is higher than the first priority during the time interval. Any number of other methods for adjusting the second priority level with respect to the first priority level are considered to be within the ambit of the present disclosure.

As shown by reference number 412, the UE 402 may perform, during a time interval, a communication corresponding to the second service based at least in part on the adjusted second priority. In some aspects, performing the communication may include transmitting a mobile-terminated page response based at least in part on receiving a mobile-terminated page. In some aspects, prior to adjusting the second priority, the second SIM may not be connected to a network corresponding to the second service. In this case, the UE 402 may perform a local connection release associated with the first service and may performing a synchronization procedure associated with the network, because the second SIM may no longer be synchronized with the network. In some aspects, for example, the UE 402 may transmit the mobile-terminated page response based at least in part on performance of the synchronization procedure.

In some aspects, performing the communication may include performing a network access registration procedure. In some aspects, the UE 402 may re-apply the second priority based at least in part on an expiration of a registration timer. In some aspects, performing the communication may include performing a mobile-terminated call task while connected to a network corresponding to the second service. In that case, the UE 402 may perform a local connection release associated with the second service, transition the second SIM to an idle mode based as least in part on performing a registration procedure associated with the network, and apply, during an additional time interval, the second priority based at least in part on transitioning the second SIM to the idle mode. For example, the UE 402 may receive, by the second SIM, a mobile-terminated page and may decode the mobile-terminated page using the second SIM, while the second SIM is in the idle mode.

As shown by reference number 414, the UE 402 may establish, based at least in part on transmitting the mobile-terminated page response, a network connection associated with the second service. As shown by reference number 416, the UE 402 may identify, based at least in part on the network connection, a communication type associated with the second service and, as shown by reference number 418, may apply, during an additional time interval and based at least in part on the communication type, at least one of the second priority or the adjusted second priority. In some aspects, for example, the communication type may include a voice call, and the UE 402 may apply the second priority. In some aspects, for example, the communication type may include a data communication, and the UE 402 may apply the adjusted second priority.

In some aspects, the UE may go out of synchronization with the network while turning to the second service. Thus, in some aspects, the UE 402 may perform a local connection release associated with the first service based at least in part on the communication type associated with the second service including a data communication. The first SIM may then perform a synchronization procedure associated with the network, thereby restoring synchronization.

In some aspects, the UE 402 may identify the at least one re-prioritization condition that is satisfied based at least in part on determining that a page repetition pattern associated with the second service fails to satisfy a pattern condition. For example, the UE 402 may receive the mobile-terminated page in accordance with the page repetition pattern, and the UE 402 may transmit the mobile-terminated page response in accordance with a page response pattern. The UE 402 may adjust the page response pattern based at least in part on a signal quality metric associated with the first service. For example, the signal quality metric may include a received signal strength indicator (RSSI), a block error rate (BLER), or a data throughput measurement.

In some aspects, the first SIM may be in connected mode when the second SIM is to start a second service (e.g., a data service and/or an MMS service). When the first service is connected and the UE 402 starts a higher priority second service, the UE 402 and the network (e.g., the network node 404) may lose synchronization as the UE 402 is tuning away from the first service to the second service, potentially leading to call failure. In some aspects, the UE 402 may identify the first service associated with the first SIM of the UE 402, the first service having a first priority. The UE 402 may identify the second service associated with the second SIM of the UE 402, the second service having a second priority and the second priority may be higher than the first priority. The UE 402 may perform a local connection release associated with the first service based at least in part on identifying the second service and transition the UE 402 to an idle mode based at least in part on performing a registration procedure associated with the network. The UE 402 may perform a communication corresponding to the second service after transitioning to the idle mode.

In some aspects, the first SIM of the UE 402 may be configured to determine that the first service comprises a long-term data service. For example, the first SIM may include an application programming interface (API), associated with the first SIM, that is configured to determine whether the first service comprises a long-term data service or a short-term data service. The API may determine that the first service comprises the long-term data service based at least in part on determining that a duration associated with the first service fails to satisfy a short-term data service duration threshold. The short-term data service threshold may be any specified threshold and/or duration range. For example, the short-term data service threshold may be specified in terms of seconds (e.g., two seconds, three seconds, four seconds, five seconds, etc.) and/or in terms of slots or subslots, among other examples.

As indicated above, FIG. 4 is provided as an example. Other examples may differ from what is described with regard to FIG. 4.

FIG. 5 is a diagram illustrating an example process 500 performed, for example, by a UE, in accordance with the present disclosure. Example process 500 is an example where the UE (e.g., UE 402) performs operations associated with techniques for adjusting a resource priority associated with a DSDS UE.

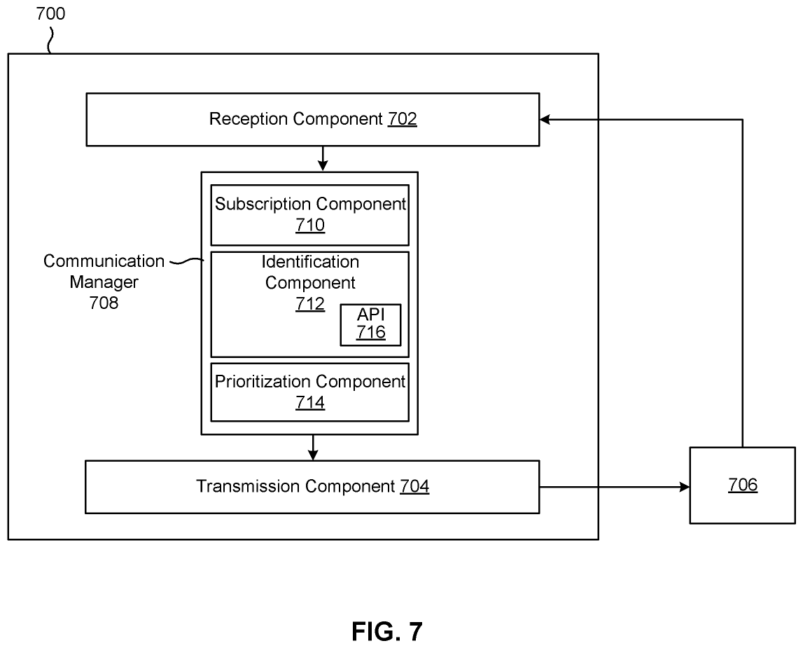

As shown in FIG. 5, in some aspects, process 500 may include identifying a first service associated with a first SIM of the UE, the first service having a first priority (block 510). For example, the UE (e.g., using communication manager 708 and/or identification component 712, depicted in FIG. 7) may identify a first service associated with a first SIM of the UE, the first service having a first priority, as described above.

As further shown in FIG. 5, in some aspects, process 500 may include identifying at least one re-prioritization condition that is satisfied, wherein the at least one re-prioritization condition is associated with at least one of the first service or a second service associated with a second SIM of the UE, the second service having a second priority and the second priority is lower than the first priority (block 520). For example, the UE (e.g., using communication manager 708 and/or identification component 712, depicted in FIG. 7) may identify at least one re-prioritization condition that is satisfied, wherein the at least one re-prioritization condition is associated with at least one of the first service or a second service associated with a second SIM of the UE, the second service having a second priority and the second priority is lower than the first priority, as described above.

As further shown in FIG. 5, in some aspects, process 500 may include adjusting, based at least in part on the at least one re-prioritization condition being satisfied, the second priority, wherein the adjusted second priority is higher than the first priority (block 530). For example, the UE (e.g., using communication manager 708 and/or prioritization component 714, depicted in FIG. 7) may adjust, based at least in part on the at least one re-prioritization condition being satisfied, the second priority, wherein the adjusted second priority is higher than the first priority, as described above.

As further shown in FIG. 5, in some aspects, process 500 may include performing, during a time interval, a communication corresponding to the second service based at least in part on the adjusted second priority (block 540). For example, the UE (e.g., using communication manager 708, reception component 702, and/or transmission component 704, depicted in FIG. 7) may perform, during a time interval, a communication corresponding to the second service based at least in part on the adjusted second priority, as described above.

Process 500 may include additional aspects, such as any single aspect or any combination of aspects described below and/or in connection with one or more other processes described elsewhere herein. In some aspects, for example, two or more of the aspects described below may be combined, as indicated below.

In a first aspect, the second SIM comprises a DDS and the first SIM comprises a non-DDS. In a second aspect, alone or in combination with the first aspect, the first service comprises at least one of a packet-switched data traffic service, a circuit-switched data traffic service, or a multimedia messaging service. In a third aspect, alone or in combination with one or more of the first and second aspects, identifying the at least one re-prioritization condition that is satisfied comprises determining that an inactive period corresponding to a periodic scheduling scheme associated with the first service satisfies a threshold. In a fourth aspect, alone or in combination with the third aspect, the periodic scheduling scheme comprises at least one of a semi-persistent scheduling configuration, a configured grant, or a discontinuous reception configuration. In a fifth aspect, alone or in combination with one or more of the first through fourth aspects, identifying the at least one re-prioritization condition that is satisfied comprises determining that a timer associated with a re-prioritization delay period has expired before a completion of a communication associated with the first service.

In a sixth aspect, alone or in combination with one or more of the first through fifth aspects, performing the communication comprises transmitting a mobile-terminated page response based at least in part on receiving a mobile-terminated page. In a seventh aspect, alone or in combination with the sixth aspect, process 500 includes establishing, based at least in part on transmitting the mobile-terminated page response, a network connection associated with the second service, identifying, based at least in part on the network connection, a communication type associated with the second service, and applying, during an additional time interval and based at least in part on the communication type, at least one of the second priority or the adjusted second priority. In an eighth aspect, alone or in combination with the seventh aspect, the communication type comprises a voice call, and applying the at least one of the second priority or the adjusted second priority comprises applying the adjusted second priority. In a ninth aspect, alone or in combination with the seventh aspect, the communication type comprises a data communication, and applying the at least one of the second priority or the adjusted second priority comprises applying the second priority. In a tenth aspect, alone or in combination with the ninth aspect, process 500 includes performing a local connection release associated with the first service based at least in part on the communication type comprising a data communication, and performing a synchronization procedure associated with the network.

In an eleventh aspect, alone or in combination with one or more of the sixth through tenth aspects, identifying the at least one re-prioritization condition that is satisfied comprises determining that a page repetition pattern associated with the second service fails to satisfy a pattern condition, wherein receiving the mobile-terminated page comprises receiving the mobile-terminated page in accordance with the page repetition pattern. In a twelfth aspect, alone or in combination with one or more of the sixth through eleventh aspects, transmitting the mobile-terminated page response comprises transmitting the mobile-terminated page response in accordance with a page response pattern, the method further comprising adjusting the page response pattern based at least in part on a signal quality metric associated with the first service. In a thirteenth aspect, alone or in combination with the twelfth aspect, the signal quality metric comprises at least one of a received signal strength indicator, a block error rate, or a data throughput measurement.

In a fourteenth aspect, alone or in combination with one or more of the first through thirteenth aspects, performing the communication comprises performing a network access registration procedure. In a fifteenth aspect, alone or in combination with the fourteenth aspect, process 500 includes re-applying the second priority based at least in part on an expiration of a registration timer.

In a sixteenth aspect, alone or in combination with one or more of the first through fifteenth aspects, performing the communication comprises performing a mobile-terminated call task while connected to a network corresponding to the second service, the method further comprising performing a local connection release associated with the second service, transitioning the second SIM to an idle mode based at least in part on performing a registration procedure associated with the network, and applying, during an additional time interval, the second priority based at least in part on transitioning the second SIM to the idle mode. In a seventeenth aspect, alone or in combination with the sixteenth aspect, process 500 includes receiving, by the second SIM, a mobile-terminated page, and decoding the mobile-terminated page using the second SIM, wherein decoding the mobile-terminated page comprises decoding the mobile-terminated page while the second SIM is in the idle mode.

In an eighteenth aspect, alone or in combination with one or more of the first through seventeenth aspects, identifying the at least one re-prioritization condition that is satisfied comprises determining that the first service comprises a long-term data service, and performing the communication comprises performing a subscription connection setup procedure associated with the second service. In a nineteenth aspect, alone or in combination with the eighteenth aspect, determining that the first service comprises a long-term data service comprises determining that a duration associated with the first service fails to satisfy a short-term data service duration threshold. In a twentieth aspect, alone or in combination with one or more of the eighteenth or nineteenth aspects, determining that the first service comprises the long-term data service comprises determining, using an application programming interface associated with the first SIM, that the first service comprises the long-term data service.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a UE, in accordance with the present disclosure. Example process 600 is an example where the UE (e.g., UE 402) performs operations associated with techniques for performing a local connection release associated with a DSDS UE.

As shown in FIG. 6, in some aspects, process 600 may include identifying a first service associated with a first SIM of the UE, the first service having a first priority (block 610). For example, the UE (e.g., using communication manager 708 and/or identification component 712, depicted in FIG. 7) may identify a first service associated with a first SIM of the UE, the first service having a first priority, as described above.

As further shown in FIG. 6, in some aspects, process 600 may include identifying a second service associated with a second SIM of the UE, the second service having a second priority and the second priority is higher than the first priority (block 620). For example, the UE (e.g., using communication manager 708 and/or identification component 712, depicted in FIG. 7) may identify a second service associated with a second SIM of the UE, the second service having a second priority and the second priority is higher than the first priority, as described above.

As further shown in FIG. 6, in some aspects, process 600 may include performing a local connection release associated with the first service based at least in part on identifying the second service (block 630). For example, the UE (e.g., using communication manager 708 and/or subscription component 710, depicted in FIG. 7) may perform a local connection release associated with the first service based at least in part on identifying the second service, as described above.

As further shown in FIG. 6, in some aspects, process 600 may include transitioning the UE to an idle mode based at least in part on performing a registration procedure associated with the network (block 640). For example, the UE (e.g., using communication manager 708 and/or subscription component 710, depicted in FIG. 7) may transition the UE to an idle mode based at least in part on performing a registration procedure associated with the network, as described above.

As further shown in FIG. 6, in some aspects, process 600 may include performing a communication corresponding to the second service after transitioning the UE to the idle mode (block 650). For example, the UE (e.g., using communication manager 708, reception component 702, and/or transmission component 704, depicted in FIG. 7) may perform a communication corresponding to the second service after transitioning the UE to the idle mode, as described above.

Process 600 may include additional aspects, such as any single aspect or any combination of aspects described below and/or in connection with one or more other processes described elsewhere herein.

In a first aspect, the first SIM comprises a DDS and the second SIM comprises a non-DDS. In a second aspect, alone or in combination with the first aspect, the second service comprises at least one of a packet-switched data traffic service, a circuit-switched data traffic service, or a multimedia messaging service. In a third aspect, alone or in combination with one or more of the first and second aspects, process 600 includes receiving, by the first SIM, a mobile-terminated page, and decoding the mobile-terminated page using the first SIM, wherein decoding the mobile-terminated page comprises decoding the mobile-terminated page while the UE is in the idle mode.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include a communication manager 708. The communication manager 708 may include one or more of a subscription component 710, an identification component 712, or a prioritization component 714, among other examples.

In some aspects, the apparatus 700 may be configured to perform one or more operations described herein in connection with FIG. 4. Additionally, or alternatively, the apparatus 700 may be configured to perform one or more processes described herein, such as process 500 of FIG. 5, process 600 of FIG. 6, or a combination thereof. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The communication manager 708 and/or the identification component 712 may identify a first service associated with a first SIM of the UE, the first service having a first priority. In some aspects, the communication manager 708 may include one or more antennas, a modem, a controller/processor, a memory, or a combination thereof, of the UE described in connection with FIG. 2. In some aspects, the communication manager 708 may be, be similar to, include, or be included in the communication manager 140 depicted in FIGS. 1 and 2. In some aspects, the communication manager 708 may include the reception component 702 and/or the transmission component 704. In some aspects, the identification component 712 may include one or more antennas, a modem, a controller/processor, a memory, or a combination thereof, of the UE described in connection with FIG. 2. In some aspects, the identification component 712 may include the reception component 702 and/or the transmission component 704.

The identification component 712 may identify at least one re-prioritization condition that is satisfied, wherein the at least one re-prioritization condition is associated with at least one of the first service or a second service associated with a second SIM of the UE, the second service having a second priority and the second priority is lower than the first priority. The prioritization component 714 may adjust, based at least in part on the at least one re-prioritization condition being satisfied, the second priority, wherein the adjusted second priority is higher than the first priority. In some aspects, the prioritization component 714 may include one or more antennas, a modem, a controller/processor, a memory, or a combination thereof, of the UE described in connection with FIG. 2. In some aspects, the prioritization component 714 may include the reception component 702 and/or the transmission component 704.

The communication manager 708, the reception component 702, and/or the transmission component 704 may perform, during a time interval, a communication corresponding to the second service based at least in part on the adjusted second priority. The communication manager 708, the reception component 702, and/or the transmission component 704 may establish, based at least in part on transmitting the mobile-terminated page response, a network connection associated with the second service. In some aspects, the subscription component 710 may include one or more antennas, a modem, a controller/processor, a memory, or a combination thereof, of the UE described in connection with FIG. 2. In some aspects, the subscription component 710 may include the reception component 702 and/or the transmission component 704.

The identification component 712 may identify, based at least in part on the network connection, a communication type associated with the second service. The prioritization component 714 may apply, during an additional time interval and based at least in part on the communication type, at least one of the second priority or the adjusted second priority.

The communication manager 708 and/or the subscription component 710 may perform a local connection release associated with the first service based at least in part on the communication type comprising a data communication. The communication manager 708, the reception component 702, the transmission component 704, and/or the subscription component 710 may perform a synchronization procedure associated with the network.

The prioritization component 714 may re-applying the second priority based at least in part on an expiration of a registration timer. The reception component 702 may receive a mobile-terminated page. The communication manager 708, the reception component 702, and/or the subscription component 710 may decode the mobile-terminated page using the second SIM, wherein decoding the mobile-terminated page comprises decoding the mobile-terminated page while the second SIM is in the idle mode. The communication manager 708 and/or the identification component 712 may determine that the first service comprises a long-term data service. For example, the communication manager 708 and/or the identification component 712 may include an API 716, associated with the first SIM, that is configured to determine whether the first service comprises a long-term data service or a short-term data service. The communication manager 708 and/or the identification component 712 may determine, using the API 716, that the first service comprises the long-term data service based at least in part on determining that a duration associated with the first service fails to satisfy a short-term data service duration threshold.

The communication manager 708 and/or the identification component 712 may identify a first service associated with a first SIM of the UE, the first service having a first priority. The communication manager 708 and/or the identification component 712 may identify a second service associated with a second SIM of the UE, the second service having a second priority and the second priority is higher than the first priority. The communication manager 708 and/or the subscription component 710 may perform a local connection release associated with the first service based at least in part on identifying the second service. The communication manager 708, the subscription component 710, the reception component 702, and/or the transmission component 704 may transition the UE to an idle mode based at least in part on performing a registration procedure associated with the network. The communication manager 708, the reception component 702, the transmission component 704, and/or the subscription component 710 may perform a communication corresponding to the second service after transitioning the UE to the idle mode. The communication manager 708, the reception component 702, and/or the subscription component 710 may receive a mobile-terminated page. The communication manager 708, the reception component 702, and/or the subscription component 710 may decode the mobile-terminated page using the first SIM, wherein decoding the mobile-terminated page comprises decoding the mobile-terminated page while the UE is in the idle mode.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a user equipment (UE), comprising: identifying a first service associated with a first subscriber identification module (SIM) of the UE, the first service having a first priority; identifying at least one re-prioritization condition that is satisfied, wherein the at least one re-prioritization condition is associated with at least one of the first service or a second service associated with a second SIM of the UE, the second service having a second priority and the second priority is lower than the first priority; adjusting, based at least in part on the at least one re-prioritization condition being satisfied, the second priority, wherein the adjusted second priority is higher than the first priority; and performing, during a time interval, a communication corresponding to the second service based at least in part on the adjusted second priority.

Aspect 2: The method of Aspect 1, wherein the second SIM comprises a dedicated data SIM (DDS) and the first SIM comprises a non-DDS.

Aspect 3: The method of either of Aspects 1 or 2, wherein the first service comprises at least one of a packet-switched data traffic service, a circuit-switched data traffic service, or a multimedia messaging service.

Aspect 4: The method of any of Aspects 1-3, wherein identifying the at least one re-prioritization condition that is satisfied comprises determining that an inactive period corresponding to a periodic scheduling scheme associated with the first service satisfies a threshold.

Aspect 5: The method of Aspect 4, wherein the periodic scheduling scheme comprises at least one of: a semi-persistent scheduling configuration, a configured grant, or a discontinuous reception configuration.

Aspect 6: The method of any of Aspects 1-5, wherein identifying the at least one re-prioritization condition that is satisfied comprises determining that a timer associated with a re-prioritization delay period has expired before a completion of a communication associated with the first service.

Aspect 7: The method of any of Aspects 1-6, wherein performing the communication comprises transmitting a mobile-terminated page response based at least in part on receiving a mobile-terminated page.

Aspect 8: The method of Aspect 7, further comprising: establishing, based at least in part on transmitting the mobile-terminated page response, a network connection associated with the second service; identifying, based at least in part on the network connection, a communication type associated with the second service; and applying, during an additional time interval and based at least in part on the communication type, at least one of the second priority or the adjusted second priority.

Aspect 9: The method of Aspect 8, wherein the communication type comprises a voice call, and wherein applying the at least one of the second priority or the adjusted second priority comprises applying the adjusted second priority.

Aspect 10: The method of Aspect 8, wherein the communication type comprises a data communication, and wherein applying the at least one of the second priority or the adjusted second priority comprises applying the second priority.

Aspect 11: The method of Aspect 10, the method further comprising: performing a local connection release associated with the first service based at least in part on the communication type comprising a data communication; and performing a synchronization procedure associated with a network.

Aspect 12: The method of any of Aspects 7-11, wherein identifying the at least one re-prioritization condition that is satisfied comprises determining that a page repetition pattern associated with the second service fails to satisfy a pattern condition, wherein receiving the mobile-terminated page comprises receiving the mobile-terminated page in accordance with the page repetition pattern.

Aspect 13: The method of any of Aspects 7-12, wherein transmitting the mobile-terminated page response comprises transmitting the mobile-terminated page response in accordance with a page response pattern, the method further comprising adjusting the page response pattern based at least in part on a signal quality metric associated with the first service.

Aspect 14: The method of Aspect 13, wherein the signal quality metric comprises at least one of: a received signal strength indicator, a block error rate, or a data throughput measurement.

Aspect 15: The method of any of Aspects 1-14, wherein performing the communication comprises performing a network access registration procedure.

Aspect 16: The method of Aspect 15, further comprising re-applying the second priority based at least in part on an expiration of a registration timer.

Aspect 17: The method of any of Aspects 1-16, wherein performing the communication comprises performing a mobile-terminated call task while connected to a network corresponding to the second service, the method further comprising: performing a local connection release associated with the second service; transitioning the second SIM to an idle mode based at least in part on performing a registration procedure associated with the network; and applying, during an additional time interval, the second priority based at least in part on transitioning the second SIM to the idle mode.

Aspect 18: The method of Aspect 17, further comprising: receiving, by the second SIM, a mobile-terminated page; and decoding the mobile-terminated page using the second SIM, wherein decoding the mobile-terminated page comprises decoding the mobile-terminated page while the second SIM is in the idle mode.

Aspect 19: The method of any of Aspects 1-18, wherein identifying the at least one re-prioritization condition that is satisfied comprises determining that the first service comprises a long-term data service, and wherein performing the communication comprises performing a subscription connection setup procedure associated with the second service.

Aspect 20: The method of Aspect 19, wherein determining that the first service comprises a long-term data service comprises determining that a duration associated with the first service fails to satisfy a short-term data service duration threshold.

Aspect 21: The method of either of Aspects 19 or 20, wherein determining that the first service comprises a long-term data service comprises determining, using an application programming interface associated with the first SIM, that the first service comprises the long-term data service.

Aspect 22: A method of wireless communication performed by a user equipment (UE), comprising: identifying a first service associated with a first subscriber identification module (SIM) of the UE, the first service having a first priority; identifying a second service associated with a second SIM of the UE, the second service having a second priority and the second priority is higher than the first priority; performing a local connection release associated with the first service based at least in part on identifying the second service; transitioning the UE to an idle mode based at least in part on performing a registration procedure associated with the network; and performing a communication corresponding to the second service after transitioning the UE to the idle mode.

Aspect 23: The method of Aspect 22, wherein the first SIM comprises a dedicated data SIM (DDS) and the second SIM comprises a non-DDS.

Aspect 24: The method of either of Aspects 22 or 23, wherein the second service comprises at least one of a packet-switched data traffic service, a circuit-switched data traffic service, or a multimedia messaging service.

Aspect 25: The method of any of Aspects 22-24, further comprising: receiving, by the first SIM, a mobile-terminated page; and decoding the mobile-terminated page using the first SIM, wherein decoding the mobile-terminated page comprises decoding the mobile-terminated page while the UE is in the idle mode.

Aspect 26: An apparatus for wireless communication at a device, comprising a processor; memory coupled with the processor; and instructions stored in the memory and executable by the processor to cause the apparatus to perform the method of one or more of Aspects 1-21.

Aspect 27: A device for wireless communication, comprising a memory and one or more processors coupled to the memory, the one or more processors configured to perform the method of one or more of Aspects 1-21.

Aspect 28: An apparatus for wireless communication, comprising at least one means for performing the method of one or more of Aspects 1-21.

Aspect 29: A non-transitory computer-readable medium storing code for wireless communication, the code comprising instructions executable by a processor to perform the method of one or more of Aspects 1-21.

Aspect 30: A non-transitory computer-readable medium storing a set of instructions for wireless communication, the set of instructions comprising one or more instructions that, when executed by one or more processors of a device, cause the device to perform the method of one or more of Aspects 1-21.

Aspect 31: An apparatus for wireless communication at a device, comprising a processor; memory coupled with the processor; and instructions stored in the memory and executable by the processor to cause the apparatus to perform the method of one or more of Aspects 22-25.

Aspect 32: A device for wireless communication, comprising a memory and one or more processors coupled to the memory, the one or more processors configured to perform the method of one or more of Aspects 22-25.

Aspect 33: An apparatus for wireless communication, comprising at least one means for performing the method of one or more of Aspects 22-25.

Aspect 34: A non-transitory computer-readable medium storing code for wireless communication, the code comprising instructions executable by a processor to perform the method of one or more of Aspects 22-25.

Aspect 35: A non-transitory computer-readable medium storing a set of instructions for wireless communication, the set of instructions comprising one or more instructions that, when executed by one or more processors of a device, cause the device to perform the method of one or more of Aspects 22-25.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
identifying a first service associated with a first subscriber identification module (SIM) of the UE, the first service having a first priority;
identifying at least one re-prioritization condition that is satisfied, wherein the at least one re-prioritization condition is associated with at least one of the first service or a second service associated with a second SIM of the UE, the second service having a second priority and the second priority is lower than the first priority;
adjusting, based at least in part on the at least one re-prioritization condition being satisfied, the second priority, wherein the adjusted second priority is higher than the first priority; and
performing, during a time interval, a communication corresponding to the second service based at least in part on the adjusted second priority.

2. The method of claim 1, wherein the second SIM comprises a dedicated data SIM (DDS) and the first SIM comprises a non-DDS.

3. The method of claim 1, wherein the first service comprises at least one of a packet-switched data traffic service, a circuit-switched data traffic service, or a multimedia messaging service.

4. The method of claim 1, wherein identifying the at least one re-prioritization condition that is satisfied comprises determining that an inactive period corresponding to a periodic scheduling scheme associated with the first service satisfies a threshold.

5. The method of claim 4, wherein the periodic scheduling scheme comprises at least one of:
a semi-persistent scheduling configuration,
a configured grant, or
a discontinuous reception configuration.

6. The method of claim 1, wherein identifying the at least one re-prioritization condition that is satisfied comprises determining that a timer associated with a re-prioritization delay period has expired before a completion of a communication associated with the first service.

7. The method of claim 1, wherein performing the communication comprises transmitting a mobile-terminated page response based at least in part on receiving a mobile-terminated page.

8. The method of claim 7, further comprising:
establishing, based at least in part on transmitting the mobile-terminated page response, a network connection associated with the second service;
identifying, based at least in part on the network connection, a communication type associated with the second service; and
applying, during an additional time interval and based at least in part on the communication type, at least one of the second priority or the adjusted second priority.

9. The method of claim 8, wherein the communication type comprises a voice call, and wherein applying the at least one of the second priority or the adjusted second priority comprises applying the adjusted second priority.

10. The method of claim 8, wherein the communication type comprises a data communication, and wherein applying the at least one of the second priority or the adjusted second priority comprises applying the second priority.

11. The method of claim 10, the method further comprising:
performing a local connection release associated with the first service based at least in part on the communication type comprising a data communication; and
performing a synchronization procedure associated with a network.

12. The method of claim 7, wherein identifying the at least one re-prioritization condition that is satisfied comprises determining that a page repetition pattern associated with the second service fails to satisfy a pattern condition, wherein receiving the mobile-terminated page comprises receiving the mobile-terminated page in accordance with the page repetition pattern.

13. The method of claim 7, wherein transmitting the mobile-terminated page response comprises transmitting the mobile-terminated page response in accordance with a page response pattern, the method further comprising adjusting the page response pattern based at least in part on a signal quality metric associated with the first service.

14. The method of claim 13, wherein the signal quality metric comprises at least one of:
a received signal strength indicator,
a block error rate, or
a data throughput measurement.

15. The method of claim 1, wherein performing the communication comprises performing a network access registration procedure.

16. The method of claim 15, further comprising re-applying the second priority based at least in part on an expiration of a registration timer.

17. The method of claim 1, wherein performing the communication comprises performing a mobile-terminated call task while connected to a network corresponding to the second service, the method further comprising:
performing a local connection release associated with the second service;
transitioning the second SIM to an idle mode based at least in part on performing a registration procedure associated with the network; and
applying, during an additional time interval, the second priority based at least in part on transitioning the second SIM to the idle mode.

18. The method of claim 17, further comprising:
receiving, by the second SIM, a mobile-terminated page; and
decoding the mobile-terminated page using the second SIM, wherein decoding the mobile-terminated page comprises decoding the mobile-terminated page while the second SIM is in the idle mode.

19. The method of claim 1, wherein identifying the at least one re-prioritization condition that is satisfied comprises determining that the first service comprises a long-term data service, and wherein performing the communication comprises performing a subscription connection setup procedure associated with the second service.

20. The method of claim 19, wherein determining that the first service comprises a long-term data service comprises determining that a duration associated with the first service fails to satisfy a short-term data service duration threshold.

21. The method of claim 19, wherein determining that the first service comprises a long-term data service comprises determining, using an application programming interface associated with the first SIM, that the first service comprises the long-term data service.

22. A method of wireless communication performed by a user equipment (UE), comprising:
identifying a first service associated with a first subscriber identification module (SIM) of the UE, the first service having a first priority;
identifying a second service associated with a second SIM of the UE, the second service having a second priority and the second priority is higher than the first priority;
performing a local connection release associated with the first service based at least in part on identifying the second service;
transitioning the UE to an idle mode based at least in part on performing a registration procedure associated with a network; and
performing a communication corresponding to the second service after transitioning the UE to the idle mode.

23. The method of claim 22, wherein the first SIM comprises a dedicated data SIM (DDS) and the second SIM comprises a non-DDS.

24. The method of claim 22, wherein the second service comprises at least one of a packet-switched data traffic service, a circuit-switched data traffic service, or a multimedia messaging service.

25. The method of claim 22, further comprising:
receiving, by the first SIM, a mobile-terminated page; and
decoding the mobile-terminated page using the first SIM, wherein decoding the mobile-terminated page comprises decoding the mobile-terminated page while the UE is in the idle mode.

26. A user equipment (UE) for wireless communication, comprising:
a memory; and
one or more processors, coupled to the memory, configured to:
identify a first service associated with a first subscriber identification module (SIM) of the UE, the first service having a first priority;
identify at least one re-prioritization condition that is satisfied, wherein the at least one re-prioritization condition is associated with at least one of the first service or a second service associated with a second SIM of the UE, the second service having a second priority and the second priority is lower than the first priority;
adjust, based at least in part on the at least one re-prioritization condition being satisfied, the second priority, wherein the adjusted second priority is higher than the first priority; and
perform, during a time interval, a communication corresponding to the second service based at least in part on the adjusted second priority.

27. The UE of claim 26, wherein the first service comprises at least one of a packet-switched data traffic service, a circuit-switched data traffic service, or a multimedia messaging service.

28. The UE of claim 26, wherein the one or more processors, to perform the communication, are configured to transmit a mobile-terminated page response based at least in part on receiving a mobile-terminated page.

29. A user equipment (UE) for wireless communication, comprising:
a memory; and
one or more processors, coupled to the memory, configured to:
identify a first service associated with a first subscriber identification module (SIM) of the UE, the first service having a first priority;
identify a second service associated with a second SIM of the UE, the second service having a second priority and the second priority is higher than the first priority;
perform a local connection release associated with the first service based at least in part on identifying the second service;
transition the UE to an idle mode based at least in part on performing a registration procedure associated with a network; and
perform a communication corresponding to the second service after transitioning the UE to the idle mode.

30. The UE of claim 29, wherein the second service comprises at least one of a packet-switched data traffic service, a circuit-switched data traffic service, or a multimedia messaging service.
